(19) United States
(12) Patent Application Publication
(10) Pub. No.: US 2007/0050676 A1
(43) Pub. Date: Mar. 1, 2007

(54) Software testing device and method, and computer readable recording medium for recording program executing software testing

(75) Inventor: Hyeon Seop Bae, Seoul (KR)

Correspondence Address: FOLEY AND LARDNER LLP;SUITE 500, 3000 K STREET NW, WASHINGTON, DC, 20007, US

(73) Assignee: Suresoft Technologies Inc.

(21) Appl. No.: 11/209,650

(22) Filed: Aug. 24, 2005

(51) Int. Cl. G06F 11/00

(52) U.S. Cl. 714/38

(57) ABSTRACT

A software testing device and method is provided. The software testing device includes: a test script unit for outputting its holding test script when a test execution signal is inputted; a test data creating unit for selecting at least one test data from at least one predetermined test data set and creating test data, and combining the created test data to the test script; and a test execution unit for receiving the test data from the test data creating unit, and executing test by the test script combined with the received test data.

### BACKGROUND OF THE INVENTION

1. Field of the Invention

The present invention relates to a software testing device and method, and more particularly, to a device and method for testing software integrity using a test script and test data.

2. Description of the Background Art

FIG. 1 illustrates the construction of a conventional software testing device that does not have the function of dynamically creating test data.

The conventional software testing device only performs a test that uses a previously prepared test case. The previously prepared test case includes a test script and the test data that are all ditermined before the software test is executed and, therefore are fixed.

In such a conventional software testing method, because the test data is fixed prior to testing, the software performed test will be insufficient or incomplete. Once the conventional software test has been performed to compensate for any insufficiense in previous tests, new test data would have to be created and used and therefore, such add final test data creation and testing increase the time and costs associated with the testing of software.

### SUMMARY OF THE INVENTION

Accordingly, an object of the present invention is to solve at least the problems and disadvantages of the background art.

An object of the present invention is to provide a software testing device and method in which test data is dynamically created during the execution of the software test according to need and in which the need to prepared test data before test execution is elimnated.

To achieve these and other advantages and in accordance with the purpose of the present invention, as embodied and broadly described, there is provided a software testing device including: a test script unit for outputting its holding test script when a test execution signal is inputted; a test data creating unit for selecting at least one test data from at least one predetermined test data set and creating test data, and combining the created test data to the test script; and a test execution unit for receiving the test data from the test data creating unit, and executing test by the test script combined with the received test data.

In another aspect of the present invention, there is provided a software testing device including: a test script unit for outputting its holding test script when a test execution signal is inputted; a test data creating unit for selecting at least one test data from a predetermined test data set and creating test data, and combining the created test data to the test script; a test execution unit for receiving the test script from the test script unit and providing the received test script to the test data creating unit, and receiving the test data from the test data creating unit and executing test by the test script combined with the received test data; and a monitoring unit for monitoring a result of the test executed in the test execution unit, and outputting a control signal for creating additional test data, to the test data creating unit depending on the monitored result.

The test data creating unit includes: a divider for dividing the data set by a predetermined reference; and a data creator for selecting at least two test data from each divided section, and creating the test data, wherein the monitoring unit outputs the control signal for creating the additional test data, to the test data creating unit for one of the divided sections where a result of test execution using the test data is different.

The divider may divide the data set according to a center value of the data set or a randomly created value, for the section where the result of test execution using the test data is different.

The data creating unit may select at least two test data from a center value, a minimal value, a maximal value, and a mean value of the data belonging to each divided section. The data creating unit may also randomly select at least two test data from the data belonging to each divided section.

The test data creating unit may decide a specific variable value among the data in the data set, and decide variable values having a dependence relationship with the specific variable value among the data belonging to the data set on the basis of the decided specific variable value.

The software testing device may further include a storage unit for storing a check table for indicating execution or non-execution of test for a path of a test targeted software, wherein the monitoring unit monitors the result of test execution using the test data, and when there exists a non-tested path, outputs the control signal for creating the additional test data to the test data creating unit, and indicates the execution of the test for a tested path at a corresponding path of the check table.

In a further another aspect of the present invention, there is provided a software testing device receiving a test execution signal, selecting at least one test data from at least one predetermined test data set, and creating test data; combining the created test data to its holding test script; executing a test by the test script combined with the test data; monitoring a result of the test; and feeding back and selecting at least one test data from at least one predetermined test data set by a control signal for creating additional test data depending on the monitored result.

In a further another aspect of the present invention, there is provided a software testing method including the steps of: (a) selecting at least one test data from at least one predetermined test data set, and creating test data; (b) combining the created test data to its holding test script; and (c) executing a test by the test script combined with the test data.

After the step (a), the method may further include the step of: (d) monitoring a result of the test execution, and deciding whether or not the test is ended and whether or not additional test data is created.

The steps (a) to (d) may be repeated until the test is ended.

The step (a) includes the steps of: (a1) dividing the data set according to a predetermined reference; and (a2) selecting at least two test data from each divided data section, and creating the test data, wherein in the step (d), creation of the additional test data is decided for a data section where a result of the test execution using the test data is different, among the divided sections.

In the step (a1), the data set may be divided with reference to a center value of the data set or a randomly created value, for the data section where the result of test execution using the test data is different.

In the step (a2), at least two test data may be selected from a center value, a minimal value, a maximal value, and a mean value of the data belonging to each divided section.

In the step (a2), at least two test data may be randomly selected from the data belonging to each divided section.

In the step (a2), a specific variable value may be decided among the data belonging to the data set, and variable values having a dependence relationship with the specific variable value may be decided on the basis of the decided specific variable value among the data belonging to the data set.

In the step (d), the result of test execution using the test data may be monitored, and when there exists a non-tested path, additional test data may be created in the test data creating unit, and it may be indicated on a tested path that the test is executed for the corresponding path of a check table for indicating execution or non-execution of the test for the path of a test targeted software.

According to the present invention, a test coverage can be improved, and various test data can be created, thereby improving a function of error detection in the testing device.

Further, the test script and the test data are separated and provided, thereby making it possible to reuse the test script.

### BRIEF DESCRIPTION OF THE DRAWINGS

The invention will be described in detail with reference to the following drawings in which like numerals refer to like elements.

FIG. 1 illustrates a construction of a conventional software testing device not having a function of dynamically creating test data;

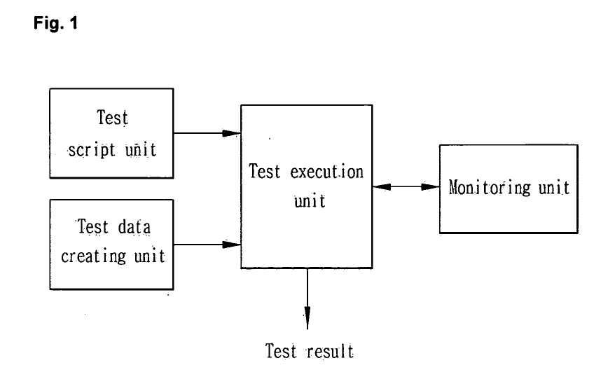

FIG. 2 illustrates a construction of a software testing device according to an embodiment of the present invention;

FIG. 3 is a block diagram illustrating a construction of a test data creating unit of a software testing device according to an embodiment of the present invention;

FIG. 4 is a flowchart illustrating a software testing method according to the present invention;

FIG. 5 is a flowchart illustrating a process of creating test data in a software testing method according to an embodiment of the present invention; and

FIG. 6 is a flowchart illustrating a process of creating test data in a software testing method according to another embodiment of the present invention.

### DETAILED DESCRIPTION OF PREFERRED EMBODIMENTS

Preferred embodiments of the present invention will be described in a more detailed manner with reference to the drawings.

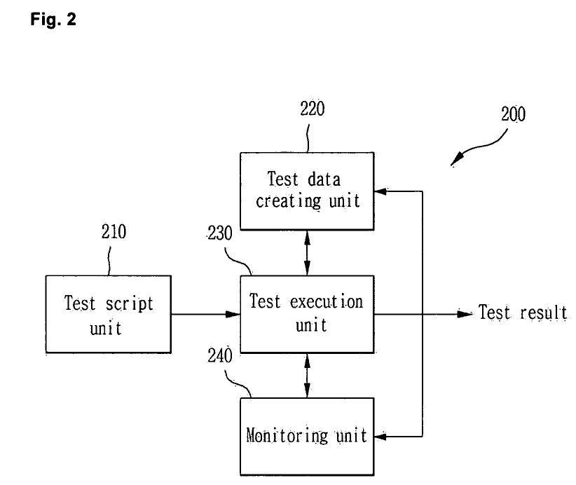

FIG. 2 illustrates a construction of a software testing device according to an embodiment of the present invention.

Referring to FIG. 2, the inventive software testing device 200 includes a test script unit 210, a test data creating unit 220, a test execution unit 230, and a monitoring unit 240.

The test script unit 210 holds a test script made before the test execution of test. The test script is comprised of calls/inputs for a test target, and a data requiring portion of the test script is comprised of a symbolic name (for example, arg).

The test data creating unit 220 dynamically creates test data. Here, the dynamic creation of the test data means creation of a suitable test data depending on a progress state of test.

The monitoring unit 240 can be included, as an additional means, in the software testing device 200. The monitoring unit 240 transmits a control signal through its monitoring and the dynamical creation of the test data depending on the monitoring, to the test data creating unit 220.

Here, only transmission of the control signal from the monitoring unit 240 is described in a preferred embodiment of the present invention, but transmission of control signal based on manual manipulation can be also be accomplished.

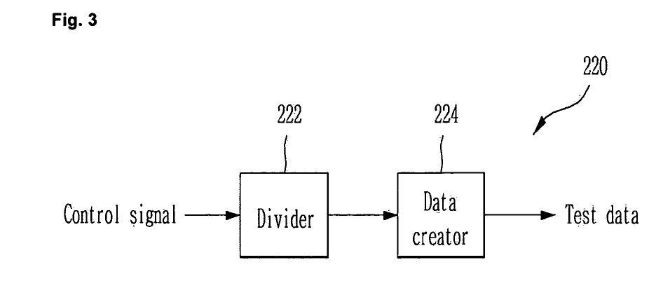

FIG. 3 is a block diagram illustrating a construction of the test data creating unit of the software testing device according to an embodiment of the present invention.

Referring to FIG. 3, the test data creating unit 220 includes a divider 222 and a data creator 224.

The divider 222 divides a data set suitable for the test. For example, if the data set suitable for the test is a natural number of 1 to 100, the divider 222 zero-divides the data set in an initial test (that is, the data set is divided at a zero time).

When the divider 222 receives an unsatisfactory monitoring result from the monitoring unit 240 after the execution of the test, it divides the data set into two sets having ranges of 1 to 50 and 51 to 100. The divider 222 continuously performs a division process until a monitoring result is satisfactory. A division reference of the divider 222 can be a center value of the data set having the unsatisfactory monitoring result. The divider 222 can randomly divide the data set having the unsatisfactory monitoring result.

The data creator 224 selects at least two data from the data section divided in the divider 222, and creates the test data. With reference to the above example, at the initial test, the data creator 224 selects numerals of 1 and 100 from the natural number of 1 to 100, and creates a first test data comprised of the selected numerals of 1 and 100. The test execution unit 230 performs the test using the first test data, and when the monitoring result is unsatisfactory, the divider 222 divides the data set into two sections of 1 to 50 and 51 to 100 as aforementioned.

The data creator 224 selects at least two test data from each divided section, and creates the test data. For example, the data creator 224 selects numerals of 2 and 45 and numerals of 52 and 95 from the data sections of 1 to 50 and 51 to 100, respectively, and creates a 2-1 test data and a 2-2 test data comprised of the selected numerals of 2 and 45 and the selected numerals of 52 and 95, respectively.

If the test result based on the 2-2 test data is unsatisfactory, the divider 222 divides the data section of 51 to 100 from which the 2-2 test data is selected, into two sections of 51 to 75 and 76 to 100. The data creator 224 selects at least two test data from the divided sections, respectively, and creates a 3-1 test data and a 3-2 test data comprised of the selected test data. The above process is repeated until the test result is satisfactory.

The data creator 220 can select the test data from a middle value, a mean value, a minimal value, and a maximal value of the data set. The data creator 220 can also randomly select the test data from the data set.

The test data creating unit 220 can create the test data on the basis of a path. In this case, the test data creating unit 220 selects at least one suitable data from the data, and creates the test data. If there exists a non-tested path as a result of monitoring, the test data is created from data not previously selected from the data set. For example, if the data set is a natural number of 1 to 100, initial test data can be the numeral of 50. If the test result using the numeral of 50 is unsatisfactory, the numeral of 79 can be the next created test data. This process is repeated until the test result is satisfactory.

In a case where the test data is created on the basis of the path, the test data creating unit 220 creates the test data based on a dependence relationship between variables. Variables in program have a mutual dependence relationship. For example, a sentence of x=y+1 exists in program, variables of “x” and “y” have a mutual dependence relationship. In other words, if either one of the variables of “x” and “y” is determined, the other one is also determined.

Accordingly, if one of the variables having the dependence relationship is determined, others are also determined. Therefore, the test data creating unit 220 can obtain the test data even without obtaining a solution of equality/inequality required in a conventional symbolic execution method.

The test execution unit 230 reads the test script stored in the test script unit 210, and provides the read test script to the test data creating unit 220. The test data creating unit 220 creates the test data necessary for testing the test script, and then outputs the test script filled with the test data, to the test execution unit 230.

The test execution unit 230 executes the test for the test script provided from the test data creating unit 220. The test execution of the test execution unit 230 is controlled by the monitoring result of the monitoring unit 240.

A controller (not shown) can also control operations of the test script unit 210, the test data creating unit 220, and the test execution unit 230, on the basis of the monitoring result received from the monitoring unit 240.

The monitoring unit 240 monitors the test result executed in the test execution unit 230. In case where the test data is dynamically created on the basis of a partition, the monitoring unit 240 determines adequacy or non-adequacy of the test, depending on identity or non-identity of the test result that is executed using at least two test data.

In a case where the test data is dynamically created on the basis of the path, the monitoring unit 240 determines the adequacy or non-adequacy of the test depending on existence or absence of a non-tested path. To determine the execution or non-execution of the test, it is required to indicate that the test is not executed for all paths before initiation of the test.

To determine execution or non-execution of a test for a path in the test-targeted software, a check table can be stored in the monitoring unit 240 or a separate storage unit (not shown). The monitoring unit 240 indicates the execution of the test for the tested path at a corresponding path of the check table.

If it is determined that the test results executed using two or more test data are different or there exists a non-tested path, the monitoring unit 240 instructs the test data creating unit 220 to create new test data.

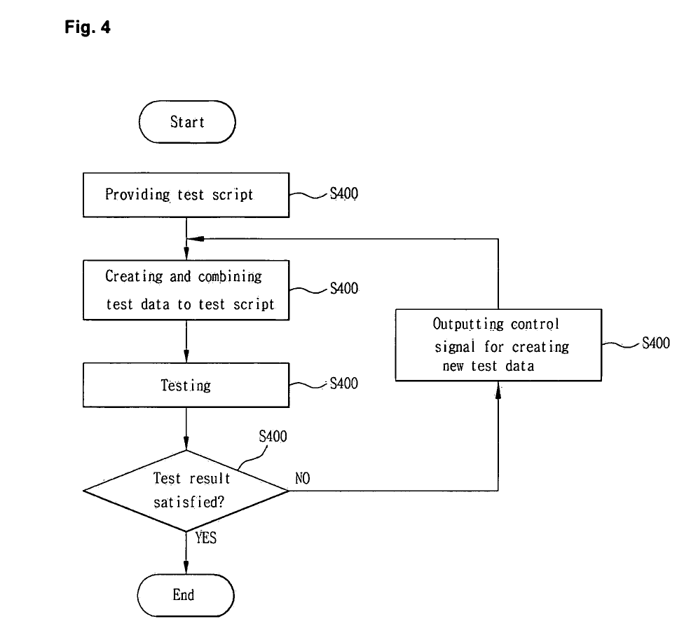

FIG. 4 is a flowchart illustrating a software testing method according to the present invention.

The test execution unit 230 outputs the test script provided by the test script unit 210, to the test data creating unit 220 (Step 400).

The test data creating unit 220 receives the test script, creates the test data necessary for the received test script, insorts the created test data in the test script, and outputs the test script to the test execution unit 230 (Step 410).

The test execution unit 230 receives the test script from the test data creating unit 220, and executes the test using the received test script (Step 420).

The monitoring unit 240 monitors the test result executed in the test execution unit 230, and determines the adequacy or non-adequacy of the test (for example, whether or not the test results executed using the different test data are identified, or whether or not all paths are tested) (Step 430).

If it is determined that the test is incomplete, the monitoring unit 240 instructs the test data creating unit 220 to create and provide new test data to the test execution unit 230 (Step 440).

Preferably, The above Steps 410 to 440 are repeated until the test is determined adequate.

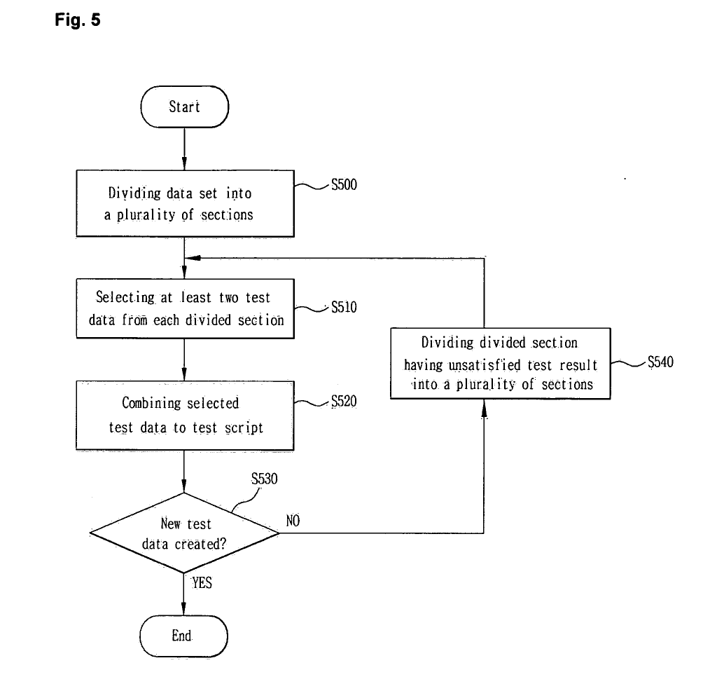

FIG. 5 is a flowchart illustrating a process of creating the test data in a software testing method according to an embodiment of the present invention.

Referring to FIG. 5, the divider 222 divides the data set suitable for the test (Step 500). The data creator 224 selects at least two test data from each divided section, and creates the test data (Step 510).

The test data creating unit 220 inserts the created test data in the test script, and then outputs the test script to the test execution unit 230 (Step 520).

The monitoring unit 240 determines that the test is incomplete (Step 530), the divider 222 divides the data set of the section determined that the test is incomplete (Step 540). The data creating unit 224 selects at least two test data from each divided section, inserts the test data in the test script, and outputs the test script to the test execution unit 230.

The section division, the data creation, the test execution, and the monitoring are repeated until the test result is satisfactory.

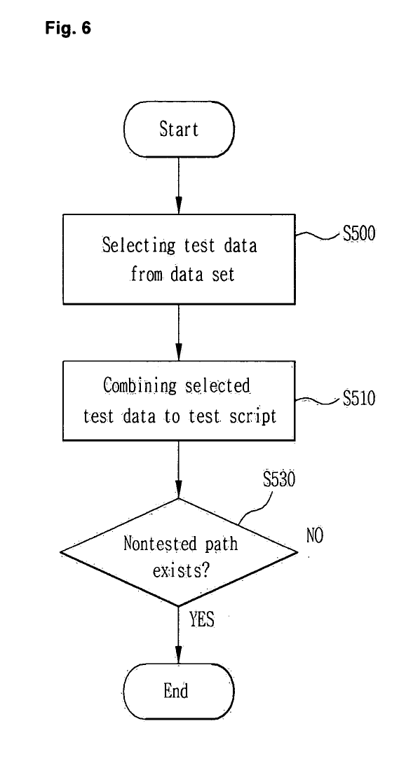

FIG. 6 is a flowchart illustrating a process of creating the test data in a software testing method according to another embodiment of the present invention.

Referring to FIG. 6, the test data creating unit 220 selects the suitable data from the data set suitable for the test, and creates the test data (Step 600). The test data creating unit 220 inserts the created test data in the test script, and then outputs the test script to the test execution unit 230 (Step 610).

The monitoring unit 240 determines that there exists a non-tested path (Step 620), the test data creating unit 220 creates the additional suitable test data from data not previously selected from the data section.

The data creation, the test execution, and the monitoring are repeated until the tests are executed for all paths.

In the above description, the method and device for dynamically creating the test data is described as a specific embodiment, but this method device can also be used in combination with a method for creating the test data based on the partition and a method for creating the test data based on the path.

Further, in the method for creating the test data based on the path, it is theoretically very difficult (NP-complete) to create the test data for testing all paths and therefore, modified examples of various algorithms, such as testing for all sentences, testing for all branches, and testing for some paths, can be made.

The present invention can be embodied using a computer readable code in a computer readable recording medium.

The computer readable recording medium includes all kinds of recording devices for storing data readable by a computer device.

The computer readable recording medium is exemplified as a Read Only Memory (ROM), a Random Access Memory (RAM), a Compact Disk-Read Only Memory (CD-ROM), a magnetic tape, a floppy disk, and an optical data storage device, and also includes a device embodied in a format of a carrier wave (for example, transmission through Internet).

The computer readable recording medium is distributed in the computer device connected through a network, and stores and executes the computer readable code in a distribution way.

According to the present invention, the test data can be dynamically created, thereby improving a test coverage, and various test data can be created, thereby improving a error detection in function the testing device.

Further, the test script and the test data are separated and provided, thereby making it possible to reuse the test script.

The invention as thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A software testing device comprising:
a test script unit for outputting its holding test script when a test execution signal is inputted;
a test data creating unit for selecting at least one test data from at least one predetermined test data set and creating test data, and combining the created test data to the test script; and
a test execution unit for receiving the test data from the test data creating unit, and executing test by the test script combined with the received test data.

2. The device of claim 1, further comprising a monitoring unit for monitoring a result of the test executed in the test execution unit, and outputting a control signal for creating additional test data, to the test data creating unit depending on the monitored result.

3. The device of claim 2, wherein the test data creating unit comprises:
a divider for dividing the data set by a predetermined reference; and
a data creator for selecting at least two test data from each divided section, and creating the test data,
wherein the monitoring unit outputs the control signal for creating the additional test data, to the test data creating unit for one of the divided sections where a result of test execution using the test data is different.

4. The device of claim 3, wherein the divider divides the data set with reference to a center value of the data set or a randomly created value, for the section where the result of test execution using the test data is different.

5. The device of claim 3, wherein the data creating unit selects at least two test data from a center value, a minimal value, a maximal value, and a mean value of the data belonging to each divided section.

6. The device of claim 3, wherein the data creating unit randomly selects at least two test data from the data belonging to each divided section.

7. The device of claim 2, wherein the test data creating unit decides a specific variable value among the data belonging to the data set, and decides variable values having a dependence relationship with the specific variable value among the data belonging to the data set on the basis of the decided specific variable value.

8. The device of claim 7, further comprising a storage unit for storing a check table for indicating execution or non-execution of test for a path of a test targeted software,
wherein the monitoring unit monitors the result of test execution using the test data, and when there exists a non-tested path, outputs the control signal for creating the additional test data to the test data creating unit, and indicates the execution of the test for a tested path at a corresponding path of the check table.

9. A software testing device comprising:
a test script unit for outputting its holding test script when a test execution signal is inputted;
a test data creating unit for selecting at least one test data from a predetermined test data set and creating test data, and combining the created test data to the test script;
a test execution unit for receiving the test script from the test script unit and providing the received test script to the test data creating unit, and receiving the test data from the test data creating unit and executing test by the test script combined with the received test data; and
a monitoring unit for monitoring a result of the test executed in the test execution unit, and outputting a control signal for creating additional test data, to the test data creating unit depending on the monitored result.

10. The device of claim 9, wherein the test data creating unit comprises:
a divider for dividing the data set by a predetermined reference; and
a data creator for selecting at least two test data from each divided section, and creating the test data,
wherein the monitoring unit outputs the control signal for creating the additional test data, to the test data creating unit for one of the divided sections where a result of test execution using the test data is different.

11. The device of claim 10, wherein the divider divides the data set with reference to a center value of the data set or a randomly created value, for the section where the result of test execution using the test data is different.

12. The device of claim 10, wherein the data creating unit selects at least two test data from a center value, a minimal value, a maximal value, and a mean value of the data belonging to each divided section.

13. The device of claim 10, wherein the data creating unit randomly selects at least two test data from the data belonging to each divided section.

14. The device of claim 9, wherein the test data creating unit decides a specific variable value among the data belonging to the data set, and decides variable values having a dependence relationship with the specific variable value among the data belonging to the data set on the basis of the decided specific variable value.

15. The device of claim 14, further comprising a storage unit for storing a check table for indicating execution or non-execution of test for a path of a test targeted software,
wherein the monitoring unit monitors the result of test execution using the test data, and when there exists a non-tested path, outputs the control signal for creating the additional test data to the test data creating unit, and indicates the execution of the test for a tested path at a corresponding path of the check table.

16. A software testing device,
receiving a test execution signal, selecting at least one test data from at least one predetermined test data set, and creating test data;
combining the created test data to its holding test script;
executing test by the test script combined with the test data;
monitoring a result of the test; and
feeding back and selecting at least one test data from at least one predetermined test data set by a control signal for creating additional test data depending on the monitored result.

17. A software testing method comprising the steps of:
(a) selecting at least one test data from at least one predetermined test data set, and creating test data;
(b) combining the created test data to its holding test script; and
(c) executing test by the test script combined with the test data.

18. The method of claim 17, after the step (a), further comprising the step of:
(d) monitoring a result of the test execution, and deciding whether or not the test is ended and whether or not additional test data is created.

19. The method of claim 18, wherein the steps (a) to (d) are repeated until the test is ended.

20. The method of claim 19, wherein the step (a) comprises the steps of:
(a1) dividing the data set by a predetermined reference; and
(a2) selecting at least two test data from each divided section, and creating the test data,
wherein in the step (d), creation of the additional test data is decided for a section where a result of the test execution using the test data is different, among the divided sections.

21. The method of claim 20, wherein in the step (a1), the data set is divided with reference to a center value of the data set or a randomly created value, for the section where the result of test execution using the test data is different.

22. The method of claim 20, wherein in the step (a2), at least two test data are selected from a center value, a minimal value, a maximal value, and a mean value of the data belonging to each divided section.

23. The method of claim 20, wherein in the step (a2), at least two test data are randomly selected from the data belonging to each divided section.

24. The method of claim 19, wherein in the step (a2), a specific variable value is decided among the data belonging to the data set, and variable values having a dependence relationship with the specific variable value are decided on the basis of the decided specific variable value among the data belonging to the data set.

25. The method of claim 24, wherein in the step (d), the result of test execution using the test data is monitored, and when there exists a non-tested path, the additional test data is created in the test data creating unit, and it is indicated on a tested path that the test is executed for the corresponding path of a check table for indicating execution or non-execution of the test for the path of a test targeted software.

26. A computer readable recording medium for recording program executing a software testing method in a computer, the method comprising the steps of:
(a) selecting at least one test data from at least one predetermined test data set, and creating test data;
(b) combining the created test data to its holding test script; and
(c) executing test by the test script combined with the test data.

27. The medium of claim 26, after the step (c), further comprising the step of:
(d) monitoring a result of the test execution, and deciding whether or not the test is ended and whether or not additional test data is created.

28. A computer readable recording medium for recording program enabling:
a test script unit for outputting its holding test script when a test execution signal is inputted;
a test data creating unit for selecting at least one test data from at least one predetermined test data set and creating test data, and combining the created test data to the test script; and
a test execution unit for receiving the test data from the test data creating unit, and executing test by the test script combined with the received test data.

29. The medium of claim 28, further enabling a monitoring unit for monitoring a result of the test executed in the test execution unit, and outputting a control signal for creating additional test data, to the test data creating unit depending on the monitored result.
